(19) United States
(12) Patent Application Publication
(10) Pub. No.: US 2025/0367734 A1
(43) Pub. Date: Dec. 4, 2025

(54) CUTTING TOOL INSERT

(71) Applicant: AB SANDVIK COROMANT, Sandviken (SE)

(72) Inventors: Leif DAHL, Sandviken (SE); Tim ULITZKA, Sandviken (SE)

(21) Appl. No.: 18/707,905

(22) PCT Filed: Nov. 10, 2022
(86) PCT No.: PCT/EP2022/081470

§ 371 Date: May 7, 2024

(30) Foreign Application Priority Data
Nov. 10, 2021 (EP) 21207533.7

(51) Int. Cl. B23B 27/14; B23K 1/00; B23K 1/008; B23K 35/30; B23K 101/00; B23K 103/18; C22C 5/08; C22C 38/00; C22C 38/02; C22C 38/04; C22C 38/06; C22C 38/44; C22C 38/50; C22C 38/52; C22C 38/54; C23C 8/26; C23C 8/38

(52) U.S. Cl. CPC B23B 27/148; B23K 1/0008; B23K 1/008; B23K 35/3006; C22C 5/08; C22C 38/002; C22C 38/004; C22C 38/02; C22C 38/04; C22C 38/06; C22C 38/44; C22C 38/50; C22C 38/52; C22C 38/54; C23C 8/26; C23C 8/38; B23K 2101/00; B23K 2103/18

(57) ABSTRACT

The present invention relates to a cutting tool insert including a carrier body made of maraging steel. The carrier body has at least one rake face, at least one flank face and at least one pocket, wherein the at least one cutting element is situated in the at least one pocket. The cutting element has at least one cutting edge and can be made of any material known in the art of cutting. The cutting tool insert further includes a braze joint joining the carrier body and the at least one cutting element, wherein the braze joint includes Ti and a Ti containing joining layer with a thickness of between 0.03 and 5 μm adjoining to the cutting element.

### RELATED APPLICATION DATA

This application is a § 371 National Stage Application of PCT International Application No. PCT/EP2022/081470 filed Nov. 10, 2022 with priority to EP 21207533.7 filed Nov. 10, 2021.

### TECHNICAL FIELD

The present invention relates to a cutting tool insert including a maraging steel carrier body and a cutting element wherein the carrier body and the cutting element are joined by brazing. The present invention also relates to a method of making such cutting tool insert.

### BACKGROUND

Welding or brazing a cutting element to a carrier body of a different material than in the cutting element is known in the art. One example of this is to braze a cutting element of polycrystalline diamond (PCD) or polycrystalline cubic boron nitride (PcBN) to a carrier body made of cemented carbide. This is done for several reasons, polycrystalline diamond (PCD) and polycrystalline cubic boron nitride (PcBN) are more expensive than cemented carbide and also more difficult to machine (i.e. to form into the desired shape) than cemented carbide. Using steel as a carrier material is not considered to be an option due to problems with brazing and low hardness and/or tensile strength of the steel. Since a cutting tool insert is subjected to large forces when used in cutting operations, the braze joint needs to be strong and the carrier body needs to have an optimum toughness/hardness ratio.

Joining steel with e.g. cemented carbide, polycrystalline diamond (PCD) or a cubic boron nitride (cBN) by brazing or welding has been known for a long time in the art of making tools. There are several challenges when joining steel with such material, e.g. differences in CTE (coefficient of thermal expansion), strength of the braze joint, undesired hardness profiles in the steel etc.

Although cemented carbide seems suitable to be used as a carrier body, it still has its disadvantages. For environmental reasons, recycling of cemented carbide is preferred which is a complicated process. Also, forming the final cemented carbide carrier requires individual pressing tools for every geometry since the basic shape of the final cemented carbide carrier body is formed by pressing prior to sintering. Also, cemented carbide is hard to machine and arriving at the final shape of the cutting tool usually requires extensive grinding etc.

### SUMMARY

One object of the present invention is to provide a cutting tool insert which has a steel carrier body that can withstand the forces during metal cutting operations.

Another object of the present invention is to provide a cutting tool insert with a cutting element joined to the steel carrier body with a high strength braze joint.

Another object of the present invention is to provide a cutting tool insert where the carrier body is easily recycled.

Another object of the present invention is to provide a cutting tool insert where the carrier body can be shaped with less effort as compared to a cemented carbide carrier body.

### Definitions

By cutting tool insert is herein meant an insert used in metal cutting applications such as milling, turning, drilling etc. The cutting tool insert includes at least one rake face and at least one flank face, and at least one cutting edge in between the rake face and flank face.

The cutting tool insert is usually fastened in a tool holder, e.g., a milling cutter or a holder for turning, or it can be fastened onto a drill. It is common that the insert is provided with a hole to facilitate fastening. The inserts are designed so that they are easily replaced when worn out. They can also be called indexable inserts. The insert can have any shape used in the art of cutting applications. In FIG. 1, one type of insert is shown.

By cutting element is herein meant the part of the cutting tool insert that is engaged in the cutting operation, i.e., the part that includes the at least one cutting edge and is in contact with the work piece. In the art, the cutting element can also be called “cutting tip”.

By carrier body is herein meant the insert body, that does not constitute the cutting element. The carrier body includes a pocket (in the art also called recess, notch, seat etc.) where the cutting element is situated. The carrier body can have any shape of a cutting tool insert, see above.

### BRIEF DESCRIPTION OF THE DRAWINGS

FIG. 1 is a schematic view of a cutting tool insert having a rake face, a flank face and a cutting edge.

FIG. 2 is a schematic view of a cutting tool insert showing the carrier body, the cutting element and the cutting edge.

FIG. 3 is a schematic view of a cutting tool insert showing the carrier body, the cutting element and the cutting edge.

FIG. 4 is a schematic view of a cutting tool insert showing the carrier body and where the cutting element has a cemented carbide support, and the cutting element material includes the cutting edge.

FIG. 5 is a cross section of the part of the cutting tool insert where a cutting element is attached to the carrier body by a braze joint.

FIG. 6 is a cross section of the part of the cutting tool insert where a cutting element is attached to the carrier body by a braze joint. The cutting element has a cemented carbide support and a cutting element material.

FIG. 7 is a LOM (Light Optical Microscope) image of the wear of a cemented carbide cutting element brazed to a maraging steel carrier according to the invention from Example 1.

FIG. 8 is a LOM (Light Optical Microscope) image of the wear of the solid cemented carbide insert according to prior art from Example 1.

FIG. 9 is a SEM (Scanning Electron Microscope) image of the wear of a PcBN cutting element brazed to a maraging steel carrier according to the invention from Example 3.

FIG. 10 is a SEM (Scanning Electron Microscope) of the wear of a PcBN cutting element brazed to a cemented carbide carrier according to prior art from Example 3.

FIG. 11 is a schematic drawing of the shear testing device.

FIG. 12 is an example of a hardness depth curve showing the hardness values decreasing from the surface towards the core where A is the average core hardness, B is the limiting hardness and C is the nitriding depth.

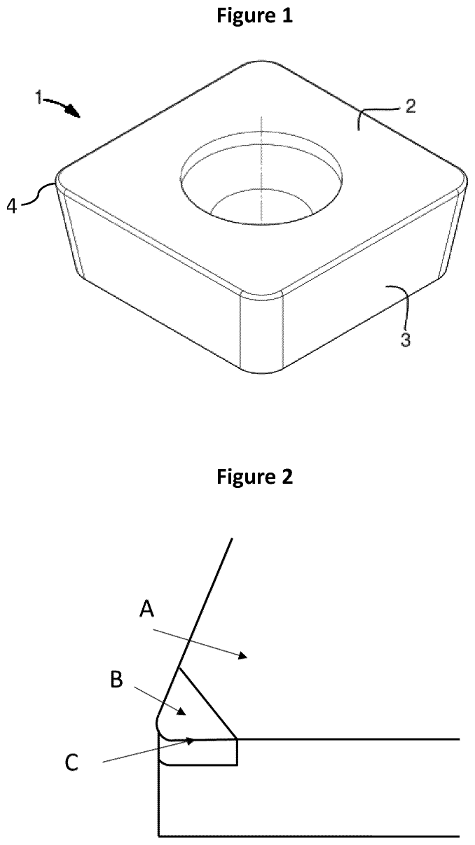

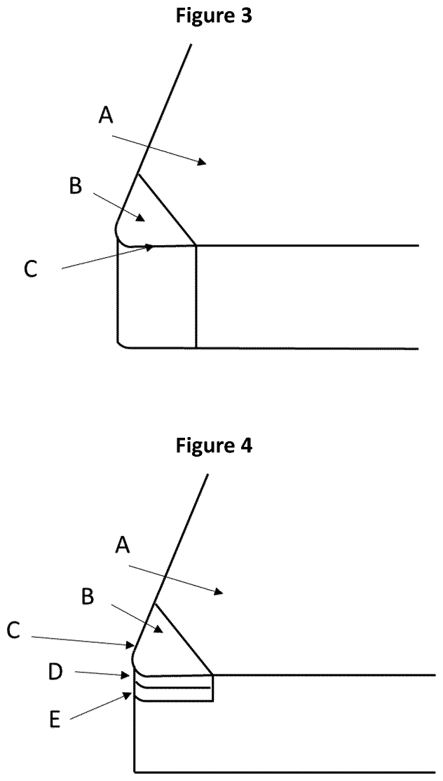

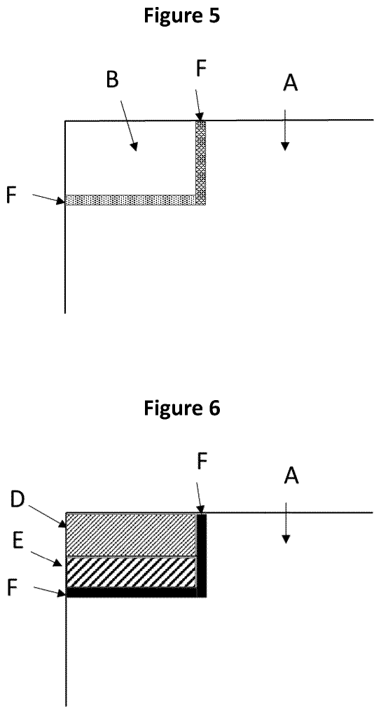

### DETAILED DESCRIPTION OF THE INVENTION

The invention relates to a cutting tool comprising a carrier body including at least one rake face and at least one flank face and at least one pocket, andat least one cutting element situated in said at least one pocket, where the cutting element includes at least one cutting edge; a braze joint, joining said carrier body and said at least one cutting element. The braze joint includes Ti and the braze joint also includes a Ti containing joining layer with a thickness of between 0.03 and 5 μm adjoining to the cutting element. The carrier body is made of maraging steel.

The cutting element can be made of any material known in the art of metal cutting, i.e., one of cemented carbide, cermets, ceramics, Polycrystalline diamond (PCD), or sintered cubic boron nitride (PcBN). The number of cutting elements brazed to a carrier body can vary depending on the specific cutting application etc., but is usually between 1 and 8.

By ceramic is herein meant a material having transition metal carbides, nitrides or carbonitrides grains, e.g., WC, Si₃N₄, SIAION, Al₂O₃/SiC-wiskers etc., embedded in an oxide ceramic matrix e.g., aluminum oxide, where the amount of transition metal carbides, nitrides or carbonitrides grains is between 5 to 45 vol %. These are generally sintered in a hot isostatic pressing process.

The cemented carbide used as a cutting element can be made of any cemented carbide known in the art. The cemented carbide includes a hard phase embedded in a metallic binder phase matrix.

By cemented carbide is herein meant that at least 50 wt % of the hard phase is WC.

Suitably, the amount of metallic binder phase is between 3 and 20 wt %, preferably between 4 and 15 wt % of the cemented carbide. Preferably, the main component of the metallic binder phase is selected from one or more of Co, Ni and Fe, more preferably the main component of the metallic binder phase is Co.

By main component is herein meant that no other elements other than those mentioned above are added to form the binder phase, however, if other components are added, like e.g. Cr, it will inevitably be dissolved in the binder during sintering.

In one embodiment of the present invention, the cemented carbide can also include other components common in cemented carbides, such as elements selected from Cr, Ta, Ti, Nb and V present as elements or as carbides, nitrides or carbonitrides.

By cermet is herein meant a material including hard constituents in a metallic binder phase, wherein the hard constituents include carbides or carbonitrides of one or more of Ta, Ti, Nb, Cr, Hf, V, Mo and Zr, such as TIN, TiC and/or TiCN.

By PCD (polycrystalline diamond) is herein meant a material including diamond crystals sintered together where the amount of diamond crystals is between 50 to 100 vol %. The diamond crystals typically have a grain size of between 0.5 and 30 μm. The PCD can also comprise one or more constituents selected from Al, Cr, Co, Ni, V, Fe and Si.

By PcBN is herein meant a material including cBN grains embedded in a metallic and/or ceramic binder where the amount of cBN grains is between 30 to 99 vol %. The ceramic binder can contain one or more constituents being carbides, nitrides, carbonitrides, borides or oxides of elements selected from Co, Ni and groups 4-6 in the periodic table of elements.

Polycrystalline diamond (PCD) and sintered cubic boron nitride (PcBN) can either be provided as it is, so called “free standing” or together with a cemented carbide support, so called “carbide backed”. Polycrystalline diamond (PCD) and sintered cubic boron nitride (PcBN) are usually manufactured by providing a suitable powder mixture which is subjected to a high temperature-high pressure (HP/HT) sintering step to form a sintered compact (typically 1400° C., 5 GPa).

When a polycrystalline diamond (PCD) and sintered cubic boron nitride (PcBN) are provided with a cemented carbide support, this is prepared already prior to the sintering of the polycrystalline diamond (PCD) and sintered cubic boron nitride (PcBN). One way of doing this is to use a cup with a cemented carbide disc in the bottom. The cup is then filled with the PCD or cBN powder mixture of choice and the cup is then sealed. The sealed cup is then subjected to a high temperature-high pressure (HPHT) sintering step. The diamond or cBN material is bonded to the cemented carbide during the sintering step. The disc can then be cut into suitable pieces using e.g. laser or WEDM (wire electrical discharge machining).

The cemented carbide used as a support for the polycrystalline diamond (PCD) and sintered cubic boron (PcBN) can be made of any cemented carbide common in the art, see the definition above.

Maraging steel is a type of steel, which is hardened by precipitation of intermetallic compounds. Maraging steels suitably contains from 8 to 25 wt % Ni and one or more alloying elements selected from Co, Mo, Ti, Al and Cr in a total amount of between 7 and 27 wt %, preferably between 7 and 23 wt % of alloying elements. Maraging steels typically contain less carbon than conventional steel, suitably 0.03 wt % C or less. The balance being Fe. In one embodiment of the present invention the maraging steel contains from 11 to 25 wt % Ni, preferably 15 to 25 wt % Ni. The alloying elements are suitably Co in an amount of from 7 to 15 wt %, preferably 8.5 to 12.5 wt % Co, Mo in an amount of from 3 to 10 wt %, 30 preferably 3 to 6 wt % Mo, Ti in an amount of from 0.1 to 1.6 wt % preferably from 0.5 to 1.2 wt % Ti, from 0 to 0.15 wt % Cr, Al in an amount of from 0 to 0.2 wt % and less than 0.03 wt % C. The balance being Fe.

In one embodiment of the present invention, the maraging steel has a composition of from 17 to 19 wt % Ni, from 8.5 to 12.5 wt % Co, from 4 to 6 wt % Mo, from 0.5 to 1.2 wt % Ti, from 0 to 0.15 wt % Cr, from 0 to 0.2 wt % Al and less than 0.03 wt % C. The balance being Fe.

In another embodiment of the present invention, the maraging steel has a composition of from 8 to 11 wt % Ni, preferably from 9 to 10 wt % Ni, from 2.5 to 4 wt % Cr, preferably from 3 to 3.5 wt % Cr, from 3.5 to 5 wt % Mo preferably from 4 to 4.5 wt % Mo, from 0.4 to 1.1 wt % Ti, preferably from 0.7 to 0.9 wt % Ti, less than 0.4 wt % Si, less than 0.4 wt % Mn and balance Fe.

As many alloys, maraging steel can also contain unavoidable impurities. By impurities is herein meant any element that can be present in the maraging steel in such small amounts that it does not have any influence on the properties of the steel. The total amount of impurities is below 0.50 wt %, preferably below 0.15 wt %. Examples of such elements are Mn, P, Si, B and S.

In one embodiment if the present invention, the amount of Mn is less than 0.05 wt %, the amount of P is less than 0.003 wt %, the amount of Si is less than 0.004 wt % and S less than 0.002 wt %.

The average hardness of the maraging steel part will depend on if any ageing/nitriding step has been performed or not, see below.

In one embodiment of the present invention the carrier body made of maraging steel is not provided with a gradient with regard to hardness the average hardness is between 300 and 1200 HV1, preferably between 500 and 1100 HV1. The standard deviation of the hardness values is suitably between 0 to 150 HV1, preferably between 0 and 100 HV1.

In one embodiment of the present invention, the average hardness of the maraging steel part is preferably between 40 and 55 HRC, more preferably between 42 and 55 HRC. The HRC values corresponds to between 390 and 610 HV1, more preferably between 400 and 610 HV1. The standard deviation of the hardness values is suitably between 0 to 2 HRC, preferably between 0 and 1.5 HRC.

In one embodiment of the present invention, the carrier body made of maraging steel is provided with a hardness gradient, i.e., the carrier body has an increased hardness in a surface zone compared to in the core. By that is herein meant that the hardness has its highest value at the surface and then gradually decreases towards the core. The carrier body made of maraging steel then has an average core hardness of between 300 and 700 HV1, preferably between 500 and 700 HV1. The standard deviation of the core hardness values is suitably between 0 to 20 HV1, preferably between 0 and 15 HV1. The surface of maraging steel then has an average surface hardness of between 300 and 1200 HV1, preferably between 500 and 1100 HV1. The standard deviation of the hardness values is suitably between 0 to 150 HV1, preferably between 0 and 100 HV1. The surface hardness is at least 30% higher than the core hardness, preferably at least 40% higher than the core hardness.

By “core” is herein meant the inner part of the maraging steel carrier body, where the hardness, when measured on a cross section, is no longer changing.

The depth of the hardness gradient as measured from the surface, the nitriding depth, is determined by making a hardness depth curve on the transverse section of a maraging steel carrier provided with a hardness gradient, measuring HV 0.3 or HV0.5 according to the standard DIN EN ISO 6507-1, starting close to the surface and towards the core until the hardness is no longer changing. The nitriding depth is given by the vertical distance from the surface of the nitrided carrier body up to the point of the limiting hardness where the limiting hardness is defined as the average core hardness+50 HV0.3 or 50 HV0.5, see FIG. 12.

The average nitriding hardness depth of the maraging steel carrier body is between 0.001 and 0.8 mm, preferably between 0.01 and 0.3 mm. The standard deviation of the hardness values is suitably between 0 to 0.03 mm preferably between 0 and 0.02 mm. By increasing the hardness on the surface of the maraging steel carrier, it will have an increased wear resistance. This can be a big advantage when the cutting tool insert according to the present invention is used in the cutting applications where the chip from work piece material hits the maraging steel carrier.

The brazing technique is the so-called active brazing. By that is meant that the joint is not just formed by melting the filler material and forming a metallic bond, it also involves a chemical reaction with one or both of the materials that are to be joined. The joining element in the filler material is usually Ti, however elements such as Hf, V, Zr and Cr are also considered to be active elements. According to this invention, Ti is the active element.

By braze joint is herein meant the area or mass between the cemented carbide and the maraging steel part that is filled by the filler material and formed during the brazing process, see below.

The thickness of the braze joint is suitably between 5 and 200 μm, preferably between 15 and 100 μm.

The braze joint is not a homogenous phase. Instead, after brazing, the elements in the filler material form different alloying phases.

The braze joint, after brazing, includes a Ti containing joining layer adjoining to the cutting element. Ti is very reactive and will, during brazing, react with one or more elements present in the cutting element. Most commonly, covalent bonds are formed with one or more of carbon, nitrogen, oxygen and boron and form a strong Ti containing joining layer at the interface between the braze joint and the cutting element.

The composition of the Ti containing joining layer will vary depending on what material the cutting element is made of but is usually composed of one of TiC, TIN, TiOₓ and TiBₓ or a mixture thereof. Since the formed joining layer is of ceramic nature, the joint may become brittle if the layer growth is uncontrolled.

For example, if the material closest to the braze joint is PCD (polycrystalline diamond) or cemented carbide, either that the whole cutting element is made of cemented carbide or if it is a carbide backed PCD or PcBN cutting element, the Ti containing joining layer is a TiC layer. The Ti in the braze joint will react with the carbon in the WC or diamond and form TiC.

Another example is that if the cutting element is made of solid (also called “free standing”) PcBN the joining layer will be TiN since Ti will react with the nitrogen in the cBN, but can also contain smaller amounts of TiBₓ, like e.g., TiB₂.

When the cutting element is made of ceramics, e.g., a Al₂O₃/WC sintered ceramic composite the joining layer will be a TiC/TiOₓ layer.

There are several ways to detect the presence of a joining layer depending on which type of equipment that is used.

If a Scanning Electron Microscope (SEM) with a high enough resolution is used, the joining layer is clearly visible adjacent the cutting element. To verify the composition of the layer, SEM-EDS (energy dispersive spectroscopy) and/or SEM-EPMA (electron probe microscopy analysis) with WDS (wave length dispersive spectroscopy) can be used to identify the individual elements in the joining layer.

In one embodiment of the present invention, the thickness of the joining layer is between 0.03 and 5 μm, preferably between 0.05 and 1 μm, more preferably between 0.05 and 0.5 μm and most preferred between 0.05 and 0.25 μm.

If the SEM image used does not have enough resolution to detect the joining layer, the accumulation of Ti and/or C at the interface between the filler material and the cutting element can be seen using e.g., SEM-EDS or SEM-EPMA with WDS. The accumulation of Ti is herein after called the Ti-accumulation layer and is one indicator that a joining layer is formed, even if not visually detected in the SEM image. The Ti-accumulation layer is considerably thicker than the actual joining layer which could mean that not all Ti will form TiC/TIN/TiOₓ/TiBₓ. The thickness of the Ti-accumulation layer is also partly affected by the analysis method.

Preferably, the braze joint, in addition to Ti, further includes one or more elements selected from Ag, Cu, Sn, In, Zr, Hf and C, more preferably from Ag, Cu and In.

The braze joint can also contain smaller amounts of other elements considered to be unavoidable impurities. By unavoidable impurities are herein meant small amounts of elements possibly present in the braze material, other than those listed above, prior to the brazing step as well as elements from the materials to be joined, e.g., Co, W etc. from the cemented carbide and Fe, Ni etc. from the maraging steel. Small amounts of the elements from the parts to be joined are unavoidably dissolved in the braze material when subjected to the increased temperature during the brazing step whereby the braze material melts and allow diffusion from the joining parts. As long as the brazing process parameters such as temperature and time are within the ranges according to the present invention, the total amount of the unavoidable impurities will be so small that it does not affect the performance of the braze joint.

The composition of the braze joint after brazing is difficult to determine since the elements are not evenly distributed. If available, the easiest way is to look at the filler material that has been used since the paste or foil is a homogenous blend. Also, the braze joint might comprise small amounts of elements from the materials to be joined, e.g. Co, W from the cemented carbide and Fe, Ni etc. from the maraging steel.

The amount of Ti and possible further elements in the braze joint could also be measured using Energy-dispersive X-ray spectroscopy analysis (EDS). However, due to the uneven distribution of the precipitated elements in the braze joint, many measuring points need to be used and the standard deviation will be large. Preferably, the braze joint includes, in average, Ag in an amount of from 30 to 80 wt %, preferably from 40 to 75 wt %, Cu in an amount of from 15 to 50 wt %, preferably from 15 to 40 wt %, more preferably from 20 to 40 wt %, Ti in an amount of from 0.3 to 15 wt %, preferably from 0.5 to 5 wt %, Sn in an amount of from 0 to 10 wt %, preferably from 0 to 2 wt % and In in an amount of from 0 to 30 wt %, preferably from 5 to 25 wt % more preferably from 10 to 25 wt %.

At the interface between the braze joint and the maraging steel part Ti is also accumulated in the braze joint where it forms a metallic bond with the iron in the steel. The thickness of the accumulation layer of Ti at the maraging steel surface is preferably between 1 and 10 μm, preferably between 2 to 5 μm and can be measured by e.g. EDS. The present invention also relates to a method of making a cutting tool insert according to the above including the steps of:
providing a maraging steel carrier body including at least one pocket;
providing at least one cutting element placed in said at least one pocket;
placing a filler material including Ti in an amount from 0.3 to 15 wt % of the filler material between and in contact with the maraging steel carrier body and the cutting element.
subjecting the maraging steel carrier body and the cutting element with the filler material in between to a brazing step in a furnace at a temperature between 60° and 780° C., for a time period of between 1 and 60 minutes and wherein the brazing takes place in vacuum.

The filler material (also called braze metal) according to the present invention contains Ti in a total amount of from 0.3 to 15 wt %, preferably 1 to 5 wt % of the filler material. The filler material of the present invention suitably has a solidus temperature of between 49° and 1125° C., preferably between 60° and 700° C. Further, the filler material of the present invention has a liquidus temperature of between 61° and 1180° C., preferably between 70° and 750° C. The filler material further includes, in addition to Ti, one or more elements selected from Ag, Cu, Sn, In, Zr, Hf and Cr.

In one embodiment of the present invention, the filler material includes Ag in an amount of from 30 to 80 wt %, preferably from 40 to 75 wt %, Cu in an amount of 15 to 50 wt %, preferably from 15 to 40 wt %, more preferably from 20 to 40 wt %, Ti in an amount of 0.3 to 15 wt %, preferably from 0.5 to 5 wt %, Sn in an amount of 0 to 10 wt %, preferably from 0 to 2 wt % and In in an amount of from 0 to 30 wt %, preferably from 5 to 25 wt % more preferably from 10 to 25 wt %.

Suitably, the filler material is provided as a foil or paste.

The filler material is provided onto the joining surfaces of the cemented carbide substrate and the steel part.

The thickness of the filler material provided on the joining surfaces prior to the brazing process depends on the type of material, i.e., foil or paste. If a paste is used, enough material is applied so that the surface that is to be brazed is covered. Typically, the thickness is between 5 and 200 μm, preferably between 15 and 100 μm.

The parts are then placed in a furnace with an inert or reducing environment, i.e. with a minimum amount of oxygen. Preferably, the brazing temperature in the furnace is between 600 and 830° C., preferably between 600 and 780° C., more preferably between 65° and 750° C. and even more preferably between 70° and 750° C. The time the parts are subjected to the elevated temperature is between 1 and 60 minutes, preferably between 5 and 15 minutes. If the time at elevated temperature is shorter, there is not enough time for the braze joint to form and the Ti to react to reach the desired strength of braze joint. If the time at elevated temperature is longer, the Ti-containing, brittle reaction zone will grow uncontrolled, which negatively influences the joint properties, e.g. shear strength.

The brazing suitably takes place in vacuum or with the presence of Argon at low partial pressure. By vacuum is herein meant that the pressure in the furnace is below 5×10⁻⁴ mbar, preferably below 5×10−5 mbar. If argon is present, the argon pressure is below 1×10⁻² mbar.

The brazing furnace used according to the present invention can be any furnace that can provide such well controlled conditions with regard to a vacuum, heating and cooling rate etc. as has been described above.

In one embodiment of the present invention the parts are, after brazing, subjected to an ageing step by subjecting the brazed parts to an elevated ageing temperature of between 30° and 600° C., preferably between 35° and 500° C. and most preferably between 40° and 440° C., for a time of between 5 minutes and 12 hours, preferably between 30 minutes and 8 hours and more preferably between 3 and 6 hours. Suitably the heating rate up to the ageing temperature preferably is between 1 to 50° C./min, preferably between 5 to 10° C./min. Suitably the cooling rate from the ageing temperature down to a temperature of at least below the solidus temperature of the filler material, preferably below 300° C., is between 1 to 50° C./min, preferably is between 5 to 10° C./min. The brazing and ageing steps can either be done in the same furnace or in two separate furnaces.

In one embodiment of the present invention, the ageing takes place directly after the brazing step in the same furnace as the brazing step takes place.

In one embodiment of the present invention, the ageing takes place directly after the brazing step in a different furnace from the vacuum brazing.

In one embodiment of the present invention, the ageing takes place in the same furnace/deposition chamber before or during deposition of a coating.

In one embodiment of the present invention, the ageing step is at least partly performed in a nitriding atmosphere. Due to the temperature during the nitriding, the ageing effect will also be there and therefore there is usually no additional separate ageing step if nitriding is performed.

The nitriding step can be performed using plasma nitriding or gas nitriding, preferably plasma nitriding. The nitriding atmosphere can be provided by a nitrogen containing gas, e.g., N₂, NH₃.

In one embodiment of the present invention, the nitriding step is performed using plasma nitriding. By that is herein meant that the nitriding takes place in vacuum vessel that is provided with a plasma generator where a nitriding atmosphere can be provided. The temperature is suitably between 30° and 600° C., preferably between 35° and 550° C. and the duration can be between 1 to 100 hours. The pressure should preferably be low, suitably between 50 and 600 Pa. For plasma nitriding the gas is preferably N₂, which can be mixed with e.g. H₂.

In one embodiment of the present invention, the nitriding step is performed using gas nitriding. The gas nitriding is preferably performed at a temperature between 45° and 600° C., preferably between 50° and 520° C. The gas nitriding is preferably done by NH₃ which is split into H₂ and N₂ in the reactor. Gas nitriding can either be performed at low pressure, preferably 0.05-0.02 MPa, or close to atmospheric pressure.

The exact temperature, duration and choice of nitriding gas is dependent on several things, the desired nitriding effect on the maraging steel, the specific type of equipment that is used etc.

In one embodiment of the present invention, the maraging steel part has the following composition of from 18 to 19 wt % Ni, from 8 to 10 wt % Co, from 4 to 6 wt % Mo, from 0.5 to 1.2 wt % Ti, from 0 to 0.15 wt % Cr, from 0 to 0.2 wt % Al, less than 0.03 wt % C, less than 0.04 wt % Si, less than 0.05 wt % Mn, less than 0.003 wt % P, less than 0.002 wt % S and less than 0.0005 wt % B. The balance being Fe. The filler material has the following composition Ag in an amount of from 40 to 75 wt %, Cu in an amount of from 15 to 40 wt %, Ti in an amount of from 0.5 to 5 wt %, Sn in an amount of from 0 to 2 wt % and In in an amount of from 5 to 25 wt %.

In one embodiment of the present invention, the maraging steel part has the following composition of from 9 to 10 wt % Ni, from 3 to 3.5 wt % Cr, from 4 to 4.5 wt % Mo, from 0.7 to 0.9 wt % Ti, less than 0.4 wt % Si, less than 0.4 wt % Mn and balance Fe. The filler material has the following composition Ag in an amount of from 40 to 75 wt %, Cu in an amount of from 15 to 40 wt %, Ti in an amount of from 0.5 to 5 wt %, Sn in an amount of from 0 to 2 wt % and In in an amount of from 5 to 25 wt %.

### Example 1

A maraging steel carrier body of insert type CNMG 120408 was made of maraging steel Böhler W720 VMR having a composition of 18.46 wt % Ni, 8.71 wt % Co, 5.00 wt % Mo, 0.68 wt % Ti, 0.09 wt % Cr, <0.0005 wt % S, <0.0030 wt % P, <0.02 wt % Mn, <0.020 wt % Si, <0.0010 wt % C, <0.06 wt % Al and <0.0005 wt % B. A pocket was created by cutting out a piece of the maraging steel at one of the corners using milling.

A cutting element of cemented carbide was provided with the same shape as the pocket. The cemented carbide had a composition of 6 wt % Co and the remaining WC. The cutting element was cut out using wire electrical discharge machining (WEDM) of a solid cemented carbide insert of the same type as the insert used for comparison (Comparison 1, see below).

The filler material was provided in the form of a paste (TB-629) from Tokyo Braze with a composition of 58-62 wt % Ag, 22-26 wt % Cu, 1.5-2.5 wt % Ti, and 13-15 wt % In. The solidus temperature is ca. 620° C., the liquidus temperature is ca. 720° C.

The paste was placed between the maraging steel carrier body and the cemented carbide cutting element so that both pieces were in contact with the paste. The assembled joining pieces were then placed into an Ipsen VFC-124 vacuum furnace where the temperature was first increased to 500° C. at a rate of 10° C./min to allow evaporation of the binder in the filler material and kept there for 20 minutes to allow uniform insert temperatures. The pieces were then heated up to 740° C. at a rate of 10° C./min. The brazing temperature 740° C. was kept for 10 minutes after which the pieces were cooled down to 300° C. at a rate of 5° C./min. After 300° C. it was free cooling.

After the brazing step, the brazed pieces were subjected to an ageing process to increase the hardness of the maraging steel. The pieces were placed in the same furnace as the brazing where the temperature was increased to the ageing temperature at a rate of 5° C./min. The ageing temperature 410° C. was kept for 4 h after which the pieces were cooled down to 200° C. at a rate of 5° C./min. After 200° C. it was free cooling.

The insert is herein denoted Invention 1.

For comparison, an insert with the same shape as Invention 1, but without a steel carrier, i.e. the whole insert was made from cemented carbide, the same composition as in the cutting element in Invention 1. This insert is herein called Comparison 1.

The inserts were tested in a longitudinal turning in Ti6Al4V with the following cutting parameters:

$${V}_{c} = 50 - 100 m / min$$

$${a}_{p} = 1 - 2 mm$$

$$f = 0.2 mm / rev$$

wet conditions

The hardness of the maraging steel after ageing displayed in Table 1 was measured as HRC in a Rockwell indent device, Wolpert Testo 2000. The average value is an average of at least 3 measurement points.

The results in flank wear (VB) in mm for different cutting parameters is shown in Table 1:

TABLE 1

| | | v_{c} = | v_{c} = | v_{c} = | v_{c} = |
|---|---|---|---|---|---|
| | | 50 m/ | 50 m/ | 75 m/ | 100 m/ |
| | | min | min | min | min |
| | | αₚ = | αₚ = | αₚ = | αₚ = |
| | | 1 mm | 2 mm | 2 mm | 2 mm |
| | | f = 0.2 | f = 0.2 | f = 0.2 | f = 0.2 |
| | | mm/rev | mm/rev | mm/rev | mm/rev |
| | | T = | T = | T = | T = |
| | HRC | 20 min | 12 min | 4 min | 4 min |
| Invention 1 | 51.35 ± 0.15 | 0.09 | 0.12 | 0.30 | 0.30 |
| Comparison 1 | n.a. | 0.08 | 0.12 | 0.32 | 0.31 |

In Table 1 it can be seen that the wear is about the same for both Invention 1 and Comparative 1 for different cutting parameters. The carrier body of maraging steel thus shows the same performance as the cemented carbide tool.

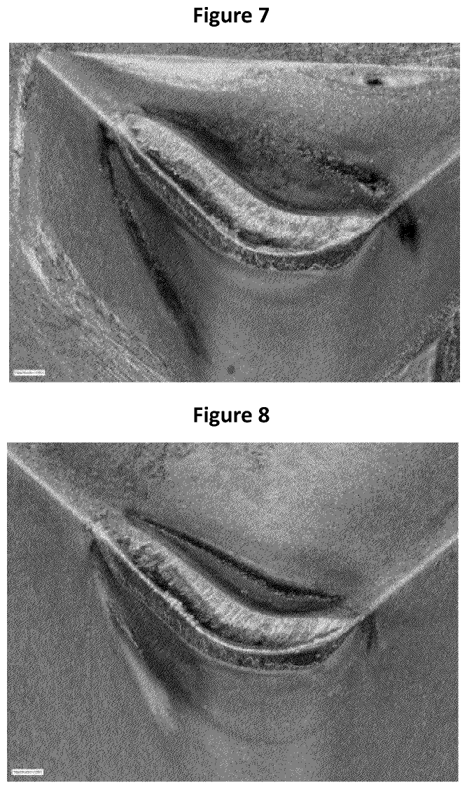

No deformation of the maraging steel carrier was observed. After the cutting test, the braze joint was unaffected when observed by the naked eye. In FIG. 7, a LOM (Light Optical Microscope) of the wear of the cutting element of Invention 1 is shown compared to a LOM (Light Optical Microscope) shown in FIG. 8 of the wear of Comparative 1, both images taken after v_{c}=100 m/min, aₚ=2 mm, f=0.2 mm/rev, and T=4 min.

### Example 2

A maraging steel carrier body of insert type CNMG 120408 was made of maraging steel Böhler W720 VMR. A pocket was created by cutting out a piece of the maraging steel at one of the corners using EDM.

A cutting element (tip) of PCD on a cemented carbide support, i.e., carbide back was provided with the same shape as the pocket. The PCD had a composition of 96 vol % diamonds with an average grain size of 6 μm and remaining Co.

The cutting tip was brazed using the same filler material and process as in Example 1. The insert was also aged using the same conditions as in Example 1.

The insert is herein denoted Invention 2.

For comparison, a carrier body with the same shape (incl. pocket) as Invention 2, but made from cemented carbide, was provided. A cutting element having the same composition as for Invention 2 was brazed to the cemented carbide carrier body using the same filler material and process (excl. ageing step) as for Invention 2. This insert is herein called Comparison 2.

Both inserts (Invention 2 and Comparison 2) were grinded after brazing and the cutting edges were brushed to form an ER of 20 μm.

The inserts were tested in a turning cutting operation in Ti6Al4V with the following cutting parameters:

$${V}_{c} = 150 m / min$$

$${a}_{p} = 0.5 mm$$

$$f = 0.12 mm / rev$$

wet conditions

Both inserts according to Invention 2 and Comparison 2 were evaluated after 18 minutes and the results in flank wear (VB) in mm are shown in Table 2.

TABLE 2

| | HRC | Flank wear (mm) |
|---|---|---|
| Invention 2 | 51.5 ± 0.15 | 0.09 |
| Comparison 2 | — | 0.10 |

In Table 2 it can be seen that the wear is about the same for both Invention 2 and Comparative 2. The carrier body of maraging steel thus shows the same performance as the cemented carbide carrier.

No deformation of the maraging steel carrier was observed. After the cutting test, the braze joint was unaffected when observed by the naked eye.

### Example 3

A maraging steel carrier body of insert type CNMG 120408 was made of maraging steel Böhler W720 VMR. A pocket was created by cutting out a piece of the maraging steel at one of the corners using milling.

A cutting element (tip) of cBN (free standing i.e. no cemented carbide support) was provided with the same shape as the pocket. The cBN had a composition of 65 vol % cBN balanced with TiCN as binder phase and unavoidable impurities.

The cutting tip was brazed using the same filler material and process as in Example 1, however now brazed at 720° C. The insert was also aged using the same conditions as in Example 1, however now at 420 for 3 h.

The insert is herein denoted Invention 3.

For comparison, a carrier body with the same shape (incl. pocket) as Invention 3, but made from cemented carbide, was provided. A cutting element having the same composition as for Invention 3 was brazed to the cemented carbide carrier body using the same filler material and process (excl. ageing step) as for Invention 3. This insert is herein called Comparison 3.

Both inserts (Invention 3 and Comparison 3) were grinded after brazing and the cutting edges were brushed to form an ER of 20 μm.

The inserts were tested in a face turning operation in case hardened steel Ovako 16NiCrS4 with the following cutting parameters:

$${V}_{c} = 180 m / min$$

$${a}_{p} = 0.1 mm$$

$$f = 0.1 mm / rev$$

### Dry Conditions

In one test, inserts according to Invention 3 and Comparison 3 were evaluated after 2.5 minutes and in an additional test, two inserts of each type of Invention 3 and Comparison 3 were evaluated after 30 minutes. In both tests flank wear (VB_{B}) and notch wear (VB_{C}) were evaluated. The results are shown in Table 3. The results from the 30 minutes test are an average of the two tests.

TABLE 3

| | | 2.5 minutes | | 30 minutes | |
|---|---|---|---|---|---|
| | | VB_{B} | VB_{C} | VB_{B} | VB_{C} |
| | HRC | (μm) | (μm) | (μm) | (μm) |
| Invention 3 | 45.99 ± 0.65 | 34 | 49 | 59 | 92 |
| Comparison 3 | — | 47 | 56 | 66 | 97 |

In Table 3 it can be seen that the wear is about the same for both Invention 3 and Comparative 3. The carrier body of maraging steel thus shows the same performance as the cemented carbide carrier.

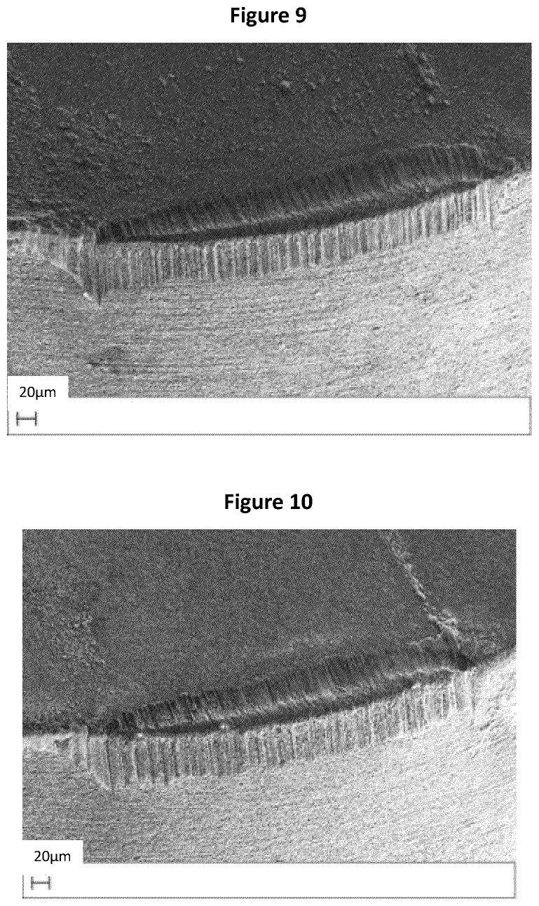

No deformation of the maraging steel carrier was observed. After the cutting test, the braze joint was unaffected when observed by the naked eye. In FIG. 9, a SEM (Scanning Electron Microscope) image of the wear of the cutting element of Invention 3 is shown compared to a SEM (Scanning Electron Microscope) image shown in FIG. 10 of the wear of Comparative 3, both images taken after 30 minutes.

### Example 4

A maraging steel carrier body of insert type CNMG 120408 was made of maraging steel Bohler W720 VMR. A pocket was created by cutting out a piece of the maraging steel at one of the corners using EDM.

A ceramic cutting element (tip) (free standing i.e. no cemented carbide support) was provided with the same shape as the pocket. The ceramic tip had a composition of 30 vol % WC, balanced with Al₂O₃ and unavoidable impurities.

The cutting tip was brazed using the same filler material and process as in Example 1. The insert was also aged using the same conditions as in Example 1.

The insert is herein denoted Invention 4.

For comparison, a carrier body with the same shape (incl. pocket) as Invention 4, but made from cemented carbide, was provided. A cutting element having the same composition as for Invention 4 was brazed to the cemented carbide carrier body using the same filler material and process (excl. ageing step) as for Invention 4. This insert is herein called Comparison 4.

Both inserts (Invention 4 and Comparison 4) were grinded after brazing and the cutting edges were brushed to form an ER of 20 μm.

The inserts were tested in a face turning operation in case hardened steel Ovako 16NiCrS4 with the following cutting parameters:

$${V}_{c} = 180 m / min$$

$${a}_{p} = 0.1 mm$$

$$f = 0.1 mm / rev$$

### Dry Conditions

Both inserts according to Invention 4 and Comparison 4 was evaluated after 2.5, 4.5 and 13.5 minutes and the results in flank wear (VBₘₐₓ) in μm are shown in Table 4.

TABLE 4

| | 2.5 min | 4.5 min | 13.5 min |
|---|---|---|---|
| Invention 4 | 211 | 203 | 368 |
| Comparison 4 | 224 | 200 | 358 |

In Table 4 it can be seen that the wear is about the same for both Invention 4 and Comparative 4. The carrier body of maraging steel thus shows the same performance as the cemented carbide carrier.

No deformation of the maraging steel carrier was observed. After the cutting test, the braze joint was unaffected when observed by the naked eye.

### Example 5

Steel parts made of maraging steel 1.2709 in the form of a cylinder were provided together with cemented carbide parts with a composition of 10 wt % Co, 1 wt % other carbides and the remaining WC. The maraging steel had a hardness of approx. 340 HV1 prior to brazing.

The braze material (Incusil ABA from WBC Group) was provided in the form of a foil with a thickness of 100 μm. The braze material had a composition of 59.0 wt % Ag, 27.5 wt % Cu, 12.5 wt % In, and 1.25 wt % Ti. The solidus temperature was ca. 605° C., the liquidus temperature was ca. 715° C.

The foil was placed between the maraging steel part and the cemented carbide part so that both pieces were in contact with the foil. The assembled joining pieces were then placed into a Schmetz vacuum furnace (type: EU 80/1H 30×45×30 6 bar System*2RV*) where the temperature was first increased to 740° C. at a rate of 20° C./min. The brazing temperature 740° C. was kept for 15 minutes after which the pieces were cooled down to 300° C. at a rate of 5° C./min. After 300° C. it was free cooling to room temperature.

Excellent wetting with no signs of thermal stress crack could be observed, proven by the high shear test result.

This sample is herein denoted Invention 5.

### Example 6

Steel parts made of maraging steel 1.2709 in the form of a cylinder were provided together with cemented carbide parts with a composition of 10 wt % Co, 1 wt % other carbides and the remaining WC. The maraging steel had a hardness of approx. 340 HV1 prior to brazing.

The braze material (TB-651 from Tokyo Braze) was provided in the form of a foil with a thickness of 100 μm. The braze material had a composition of 65.0 wt % Ag, 28.0 wt % Cu, 2.0 wt % Ti, and 5.0 wt % Sn. The solidus temperature was ca. 700° C., the liquidus temperature was ca. 750° C.

The foil was placed between the maraging steel part and the cemented carbide part so that both pieces were in contact with the foil. The assembled joining pieces were then placed into a Schmetz vacuum furnace (type: EU 80/1H 30×45×30 6 bar System*2RV*) where the temperature was first increased to 815° C. at a rate of 20° C./min. The brazing temperature 815° C. was kept for a time 15 minutes after which the pieces were cooled down to 300° C. at a rate of 5° C./min. After 300° C. it was free cooling.

An excellent wetting with no signs of thermal stress crack could be observed, proven by the high shear test result.

This sample is herein denoted Invention 6.

### Example 7 (Plasma Nitriding)

Samples according to Invention 5 and 6 were subjected to a plasma nitriding step in a gas flow of 350:50 ml/min H₂:N₂ at a chamber pressure of 3 mbar. The temperature in the chamber was 490° C. The time the samples were subjected to the plasma nitriding step was 16 hours. No masking of the braze joint was used before the nitriding.

### Example 8 (Gas Nitriding)

A sample according to Invention 1 was subjected to a gas nitriding step by NH₃ splitting. The temperature in the chamber was 510° C. The time the samples were subjected to the gas nitriding step was 23 or 55 hours. No masking of the braze joint was used before the nitriding.

### Example 9

The samples were analyzed with respect to shear strength, surface hardness, core hardness and hardness depth curve.

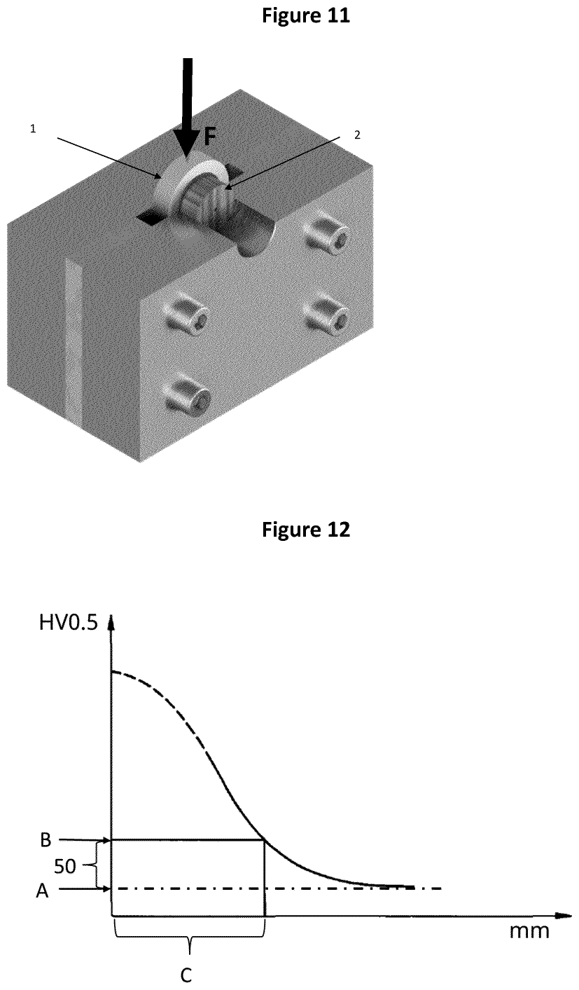

The shear strength was analyzed by a shear device set-up as shown in FIG. 11 where 1 is the steel part in the shape of a steel cylinder (Ø=20 mm, h=5 mm) and 2 is the cemented carbide part in the shape of a cemented carbide cylinder (Ø=10 mm, h=5 mm. The steel cylinder is positioned in the gap of the shear strength test device and therefore can only be moved in the loading direction. A notch, which was eroded into the surface of the device, held the joined parts in the right position and guarantees an evenly distributed force induction into the braze joint. The applied force, F, was constantly increased until the braze joint failed and the cemented carbide cylinder sheared off. The ultimate shear strength was then calculated by the quotient of the maximal measured force and the initial joining surface (A=78.5 mm²). The braze material was not removed before the determination of brazed joint shear strength.

To determine the depth of the nitriding on the sample prepared according to Example 7, the average nitriding hardness depth was determined at room temperature. This was done by making a hardness depth curve by, on the transverse section of a nitrided sample, measuring HV 0.3 according to the standard DIN EN ISO 6507-1, starting with the first indent 0.025-0.1 mm from the edge, and then every 0.03-0.10 mm until the hardness did not change anymore. The hardness values obtained are recorded as a function of the distance from the surface. From this hardness curve, the nitriding hardness depth was taken as the distance between the surface and the limiting hardness (where the limiting hardness is the average core hardness (in HV 0.3)+50HV 0.3). For samples prepared according to Example 8, the nitriding depth was determined in the same way as the samples from Example 7, but with the difference that HV 0.5 was used.

The Core hardness given in Table 5, is in HV1 and has been measured by a Vickers hardness tester on a cross section of the maraging steel part, applying a load of 1 kgf (kilogram force) and a loading time of 15 s.

A pattern of 5 indents placed 1.5 mm apart was performed according to the standard and the value given in Table 5 is an average of the 5 indents.

The surface hardness measurements were performed on the nitrided surface and where at least 5 indents placed 1.5 mm apart was performed and the value given in Table 1 is an average of the 5 indents. The measurements were performed using a Vickers hardness tester, applying a load of 1 kgf (kilogram force) and a loading time of 15 s.

TABLE 5

| | | | | Average | | | |
|---|---|---|---|---|---|---|---|
| | | | | nitriding | | | |
| | | TiC | Ti-acc. | hardness | Shear | Core | Surface |
| | | layer | Layer | depth | strength | hardness | hardness |
| Sample | nitriding | (nm) | (μm) | (mm) | (MPa) | (HV1) | (HV1) |
| Invention 5 | Plasma | — | — | 0.07 | 150.2 | 522.8 | 878 |
| | nitriding | | | | | | |
| Invention 5 | Gas | — | — | 0.16 | 127.7 | 487 | 739 |
| | nitriding | | | | | | |
| | (23 h) | | | | | | |
| Invention 5 | Gas | 142 | — | 0.17 | 108.2 | 505.3 | 821 |
| | nitriding | | | | | | |
| | (55 h) | | | | | | |
| Invention 6 | Plasma | — | 1-1.5 | 0.08 | 121.3 | 599.2 | 898 |
| | nitriding | | | | | | |

As can be seen in the Table 1, the nitriding will create a surface with considerably higher hardness than the core which will lead to an increased wear resistance.

1. A cutting tool insert comprising:
a carrier body including at least one rake face, at least one flank face and at least one pocket;
at least one cutting element situated in the at least one pocket, wherein the at least one cutting element includes at least one cutting edge; and
a braze joint joining the carrier body and the at least one cutting element, wherein the braze joint includes Ti and wherein the braze joint includes a Ti containing joining layer with a thickness of between 0.03 and 5 μm adjoining to the cutting element, and wherein the carrier body is made of maraging steel.

2. The cutting tool insert according to claim 1, wherein the cutting element is made of one of cemented carbide, ceramics, Polycrystalline diamond (PCD), or sintered cubic boron nitride (PcBN).

3. The cutting tool insert according to claim 1, wherein the composition of the Ti containing joining layer is one of TiC, TiN, TiOₓ and TiBₓ or a mixture thereof.

4. The cutting tool insert according to claim 1, wherein the maraging steel includes 8 to 25 wt % Ni, one or more alloying elements selected from Co, Mo, Ti, Al and Cr in a total amount of between 7 to 27 wt %, less than 0.03 wt % C, and a balance of Fe and impurities.

5. The cutting tool insert according to claim 1, wherein the maraging steel includes 11 to 25 wt % Ni, 7 to 15 wt % Co, from 3 to 10 wt % Mo, 0.1 to 1.6 wt % Ti, from 0 to 0.15 wt % Cr, from 0 to 0.2 wt % Al, less than 0.03 wt % C, and with a balance of Fe and impurities.

6. The cutting tool insert according to claim 1, wherein the maraging steel includes 15 to 25 wt % Ni, 8.5 to 12.5 wt % Co, from 3 to 6 wt % Mo, 0.5 to 1.2 wt % Ti, from 0 to 0.15 wt % Cr, from 0 to 0.2 wt % Al, less than 0.03 wt % C, and with a balance of Fe and impurities.

7. The cutting tool insert according to claim 1, wherein the braze joint includes Ag in an amount of from 30 to 80 wt %, Cu in an amount of 15 to 50 wt %, Ti in an amount of 0.3 to 15 wt %, Sn in an amount of 0 to 10 wt % and In in an amount of 0 to 30 wt %.

8. The cutting tool insert according to claim 1, wherein the carrier body of maraging steel has an average core hardness of between 300 and 700 HV1, and an average surface hardness of between 300 and 1200 HV1.

9. The cutting tool insert according to claim 1, wherein the carrier body of maraging steel is provided with a hardness profile so that the surface hardness is at least 30% higher than the core hardness.

10. A method of making a cutting tool insert according to any of claims 1-9 comprising the steps of:
providing a carrier body made of maraging steel, the carrier body including at least one rake face, at least one flank face and at least one pocket;
providing at least one cutting element comprising having at least one cutting edge;
providing a maraging steel part;
placing a filler material including Ti in an amount of 0.3 to 15 wt % of the filler material between and in contact with the carrier body and the cutting element; and
subjecting the carrier body and the cutting element with the filler material in between to a brazing step in a furnace at a temperature between 60° and 830° C., for a time period of between 1 and 60 minutes, and wherein the brazing takes place in vacuum.

11. The method according to claim 10, wherein the brazing takes place at a temperature between 650 and 750° C. for a time period of between 5 and 15 minutes.

12. The method according to claim 10, wherein the carrier body and the cutting element with the filler material in between is subjected to an ageing step at a temperature of between 300 and 600° C. for between 5 minutes and 12 hours.

13. The method according to claim 12, wherein the ageing step takes place at a temperature between 350 and 500° C. for a time of between 30 minutes and 8 hours.

14. The method according to claim 10, wherein the carrier body and the cutting element, after the brazing step, are subjected to a nitriding step at a temperature of between 30° and 600° C. in a nitriding atmosphere.

15. The method according to claim 14, wherein the nitriding step is plasma nitriding at a temperature of between 300 and 600° C., at a pressure of between 50 and 600 Pa for 1 to 100 hours in a nitriding atmosphere.
